(19) United States
(12) Patent Application Publication
(10) Pub. No.: US 2004/0005074 A1
(43) Pub. Date: Jan. 8, 2004

(54) Hi-fi tweeter

(75) Inventor: Chang George, Tainan (TW)

Correspondence Address: Bacon & Thomas, 4th Floor, 625 Slaters Lane, Alexandria, VA, 22314, US

(73) Assignee: Sun Technique Electric Co., Ltd., Fengshan City (TW)

(21) Appl. No.: 10/189,544

(22) Filed: Jul. 8, 2002

(51) Int. Cl. H04R 1/00; H04R 9/06; H04R 11/02

(52) U.S. Cl. 381/400

(57) ABSTRACT

A hi-fi tweeter mainly comprises a diaphragm, an inner supporting edge, a voice coil, and a phase sensitive rectifier. The diaphragm is integrated with a coil core portion, made of unitary material to avoid structurally connecting to different material, and the inner supporting edge mounting the diaphragm and the coil core portion to the phase sensitive rectifier. The voice coil is wound around the coil core portion and produces excellent ultrahigh sound wave in 1 KHz-100 KHz range.

### BACKGROUND OF THE INVENTION

1. Field of the Invention

The present invention is related to a hi-fi tweeter and more particularly to a diaphragm integrated with a voice coil core portion of a voice coil whose inner supporting edge substitutes for a conventional outer supporting edge, so as to reducing losses of sound wave in 1 KHz-100 KHz range and thereby effectively producing excellent sound wave.

2. Description of the Related Art

Referring to FIG. 1, a well-known hi-fi tweeter mainly includes a U-iron member 81, a magnet 82, a pole plate 83, a diaphragm 84, an outer supporting edge 841, a voice coil 85, a coil core portion 851, and a frame 86. The U-iron member 81, like a bowl-shaped member, is made of magnetic conductive material and adapted to receive the magnet 82 in its bottom. The magnet 82 connects to the pole plate 83 on its top. The outer periphery of the diaphragm 84 is adhered to the frame 86 at its outer supporting edge 841 by adhesive. A connected portion between the diaphragm 84 and the outer supporting edge 841 is further adhered to the coil core portion 85 at its bottom by adhesive (not labeled). The voice coil 85, which winds around the coil core portion 851, is positioned in a gap formed by the U-iron member and the pole plate 83.

The voice coil 85, however, generates sound waves particularly in 1 KHz-100 KHz when energized. Some hi-fi sound wave of the voice coil 85 may be absorbed or generated mutual interference of reflective wave, as shown in FIG. 2, while being transmitted through different impedance/transmitting-speed material's interface (including diaphragm 84, an outer supporting edge 841, a coil core portion 851, and a frame 86) prior to the diaphragm 84. Consequently, the diaphragm 84 is incapable of producing excellent sound wave. In particular, the above-mentioned problem often results in considerable acoustics drawbacks in 1 KHz-100 KHz range of ultrahigh sound wave of an ultra hi-fi tweeter.

The present invention intends to provide a hi-fi tweeter comprising diaphragm integrated with a coil core portion, made of unitary material, and an inner supporting edge mounting the diaphragm and the coil core portion on which to wind around a voice coil to a phase sensitive rectifier. Consequently, ultrahigh frequency in 1 KHz-100 KHz range produced by the voice coil can avoid to be absorbed by different material interface or to be interfered to generate disorderly reflective wave in such a way to mitigate and overcome the above problem.

### SUMMARY OF THE INVENTION

The primary objective of this invention is to provide a hi-fi tweeter comprising a diaphragm integrated with a voice coil core portion of a voice coil whose inner supporting edge substitutes for a conventional outer supporting edge and structurally supports the diaphragm, so as to producing excellent sound wave.

The secondary objective of this invention is to provide the hi-fi tweeter comprising a diaphragm integrated with a voice coil core portion of a voice coil, so as to producing excellent sound wave.

The present invention is the hi-fi tweeter. The hi-fi tweeter mainly comprises a diaphragm, an inner supporting edge, a voice coil, and a phase sensitive rectifier. The diaphragm is integrated with a coil core portion, made of unitary material to avoid structurally connecting to different material, and the inner supporting edge mounting the diaphragm and the coil core portion to the phase sensitive rectifier. The voice coil is wound around the coil core portion and produces excellent ultrahigh sound wave in 1 KHz-100 KHz range.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is a cross-sectional view of a conventional hi-fi tweeter in accordance with the prior art;

FIG. 2 is a frequency response diagram of the conventional hi-fi tweeter in accordance with the prior art;

FIG. 3 is a cross-sectional view of a hi-fi tweeter in accordance with a first embodiment of the present invention;

FIG. 4 is a cross-sectional view of a hi-fi tweeter in accordance with a second embodiment of the present invention; and

FIG. 5 is a frequency response diagram of the conventional hi-fi tweeter in accordance with the present invention.

DETAILED DESCRIPTION OF THE INVENTION

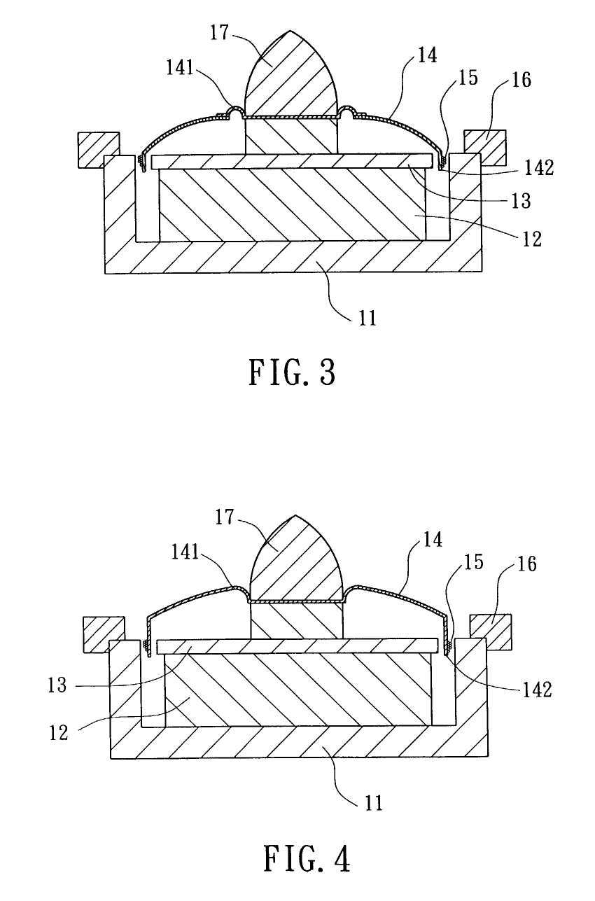

Construction of the hi-fi tweeter shall be described in detail, referring now to FIG. 3. Referring initially to FIG. 3, a hi-fi tweeter in accordance with a first embodiment of the present invention includes a U-iron member 11, a magnet 12, a pole plate 13, a diaphragm 14, a voice coil 15, and a frame 16. The U-iron member 11, like a bowl-shaped member, is made of magnetic conductive material and adapted to receive the magnet 12 in its bottom. The magnet 12 connects to the pole plate 13 on its top to form a magnetic gap. The diaphragm 14 is integrated with a coil core portion 142, and directly suspended around a phase sensitive rectifier 17 by an inner supporting edge 141 attaching thereto which substitutes for the conventional outer supporting edge attaching to the frame.

Referring again to FIG. 3, the voice coil 15 is wound around the coil core portion 142 and the combined voice coil and coil core portion is positioned in a gap formed by the U-iron member 11, the magnet 12, and the pole plate 13. The voice coil 15, when being energized in the magnetic field generated by the U-iron member 1 1, the magnet 12, and the pole plate 13, produces sound wave which may transmit to the diaphragm 14 to thereby spread to ambiance. In structure, the frame 16 is used to protect the diaphragm 14 from damage and secure to the hi-fi tweeter. The phase sensitive rectifier 17 is projected from the center of the pole plate 13 and capable of eliminating disorderedly reflective wave of the sound wave generated by interference. Consequently, excellent ultrahigh sound wave in 1 KHz-100 KHz range produced by the diaphragm 14 can avoid energy losses.

Referring to FIG. 4, reference numerals of a second embodiment have applied the identical numerals of the first embodiment. The hi-fi tweeter of the second embodiment has the similar configuration and same function as the first embodiment and the detailed descriptions are omitted.

Referring again to FIG. 4, the hi-fi tweeter in accordance with a second embodiment of the present invention further includes an inner supporting edge 141 integrated with the diaphragm 14 and made of unitary material. Accordingly, the diaphragm 14, inner supporting edge 141, and the coil core portion 142 are structurally integrated as a singular member.

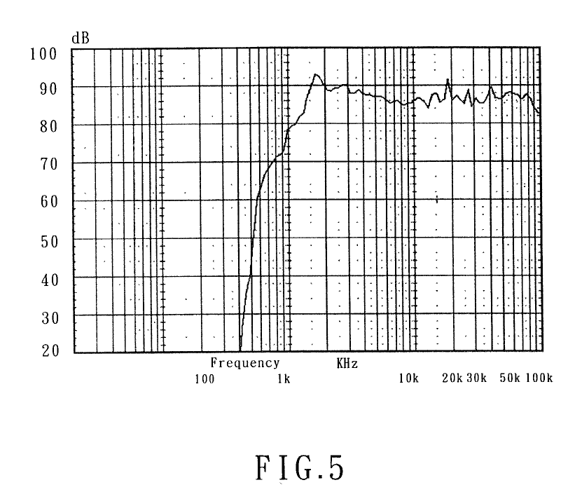

Referring to FIGS. 3 through 5, the hi-fi tweeter in accordance with the present invention has a frequency response curve in 1 KHz-100 KHz range resulting from the singular member consisting of the diaphragm 14, inner supporting edge 141, and the coil core portion 142 which made of unitary material. Due to this, the diaphragm 14 utilizes the inner supporting edge 141 directly suspending it around the phase sensitive rectifier 17 which substitutes for the conventional outer supporting edge attaching to the frame made of different material. Consequently, no sound wave produced by the voice coil 15 transmits through any interface formed by different material prior to the diaphragm 14. Ultrahigh sound wave produced by the voice coil 15 can avoid energy losses and thereby the diaphragm 14 produces excellent sound wave in 1 KHz-100 KHz range.

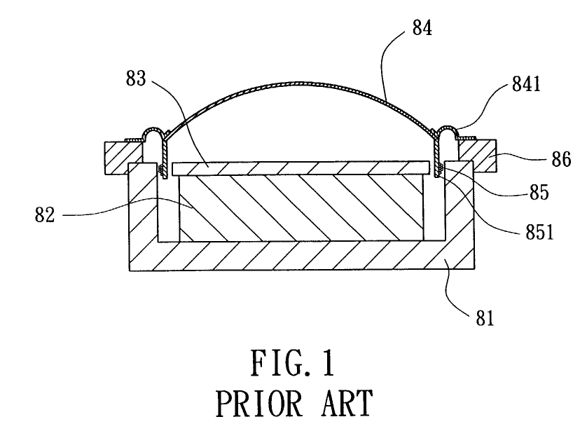

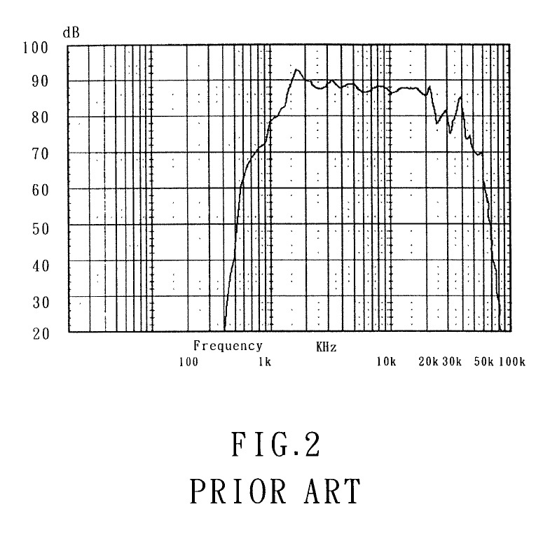

Referring back to FIGS. 1, 3, and 4, the inner periphery of the diaphragm 14 of the tweeter, as best shown in FIGS. 3 and 4, utilizes the inner supporting edge 141 directly suspending it around the phase sensitive rectifier 17 such that it can completely produce ultrahigh sound wave. In contrast to the present invention, the outer periphery of the diaphragm 84 of the tweeter, as shown in FIG. 1, utilizes the outer supporting edge 841 adhering to the frame 86, so as to supporting the diaphragm 84 and the voice coil 85 that results in producing incomplete ultrahigh sound wave.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A hi-fi tweeter, comprising:
a diaphragm transmitting sound wave to spread to ambiance and comprising a coil core portion;
a voice coil wounding around the coil core portion;
a phase sensitive rectifier being adapted to eliminate disorderedly reflective wave of sound wave generated by interference; and
an inner supporting edge being adapted to secure the diaphragm to the phase sensitive rectifier.

2. The hi-fi tweeter as defined in claim 1, wherein the inner supporting edge is integrated with the diaphragm as a singular member.

3. The hi-fi tweeter as defined in claim 2, wherein the inner supporting edge and the diaphragm are made of unitary material.

4. The hi-fi tweeter as defined in claim 1, wherein the inner supporting edge and the coil core portion are integrated with the diaphragm as a singular member.

5. The hi-fi tweeter as defined in claim 1, further comprises a U-iron member, a magnet, a pole plate, and a frame.

6. The hi-fi tweeter as defined in claim 5, wherein the coil core portion and the voice coil thereon are positioned in a gap formed by the U-iron member and the pole plate.
